(19) United States
(12) Patent Application Publication
(10) Pub. No.: US 2014/0355243 A1
(43) Pub. Date: Dec. 4, 2014

(54) Lighting device comprising a reflector device

(71) Applicant: KONINKLIJKE PHILIPS N.V., EINDHOVEN (NL)

(72) Inventors: Jianghong Yu, Best (NL); Barry Mos, Bocholt (BE); Gilbert Martinus Verbeek, Eindhoven (NL); Giovanni Cennini, Eindhoven (NL)

(73) Assignee: KONINKLIJKE PHILIPS N.V., EINDHOVEN (NL)

(21) Appl. No.: 14/368,816

(22) PCT Filed: Dec. 19, 2012
(86) PCT No.: PCT/IB12/57471

§ 371 Date: Jun. 26, 2014

Related U.S. Application Data
(60) Provisional application No. 61/580,402, filed on Dec. 27, 2011.

(51) Int. Cl. F21V 7/00; F21K 99/00

(52) U.S. Cl. CPC F21V 7/0066; F21K 9/17; F21K 9/56; F21Y 2101/02
USPC 362/84; 362/223; 362/217.05

(57) ABSTRACT

The present invention relates to a lighting device (100) comprising a tubular portion (102), which is elongate and which has a light transmissive light outlet portion (104); solid state light emitting elements (114) generating light, which is outlet through the light outlet portion (104); a reflector (106) mounted within the tubular portion (102); and a light diffusing element (108) which is arranged to diffuse the generated light before being emitted from the lighting device (100). The reflector (106) is non-planar and defines a reflector opening (146). The solid state light emitting elements (114) are mounted at the reflector (106), and the reflector (106) is provided with at least one shielding portion (126,128), shielding the generated light from passing directly from the solid state light emitting elements (114) through the reflector opening (146).

### FIELD OF THE INVENTION

The present invention relates to a lighting device comprising a tubular portion, which is elongate and which has a light transmissive light outlet portion; solid state light emitting elements generating light, which is outlet through the light outlet portion; a reflector mounted within the tubular portion; and a light diffusing element, which light diffusing element is arranged to diffuse the generated light before being emitted from the lighting device.

### BACKGROUND OF THE INVENTION

Recent years traditional fluorescent tubes have been modernized in that the outer features of the tube and the electric connection parts have been kept but the light generation has been replaced with modern technology of solid state light emitting elements, such as LEDs (Light Emitting Diodes), and OLEDs (Organic Light Emitting Diodes), etc. One example thereof is EnduraLED T8 manufactured by Philips. Typically, several solid state light emitting elements are mounted in a line on a carrier, which is introduced into a glass tube, and the inside of the glass tube is provided with a diffuser, which diffuses the spot shaped light from the solid state light emitting elements into a homogeneous light output. Present diffusers obtain the diffusing effect by a combination of reflection and scattering transmission of the light. However, in order to obtain a good uniformity of light output the solid state light emitting elements have to be densely mounted or the diffuser has to be reflective to a high extent. A high reflectivity causes a low optical efficiency. Densely mounted solid state light emitting elements cause a high cost.

### SUMMARY OF THE INVENTION

It is an object of the present invention to provide a tubular lighting device that alleviates the above-mentioned problems of the prior art, and provides a homogeneous light output with high optical efficiency at a lower density than the prior art lighting devices.

The object is achieved by a lighting device according to the present invention as defined in claim 1.

The invention is based on the insight that avoidance of a direct light path from the solid state light emitting elements to the viewer creates a basis for solving the prior art problems.

Thus, in accordance with an aspect of the present invention, there is provided a lighting device comprising a tubular portion, which is elongate and which has a light transmissive light outlet portion; solid state light emitting elements arranged to generate light, which is outlet through the light outlet portion; and a reflector mounted within the tubular portion. The reflector is non-planar and defines a reflector opening. The solid state light emitting elements are mounted at the reflector, and the reflector is provided with at least one shielding portion, shielding the generated light from passing directly from the solid state light emitting elements through the reflector opening. Preferably, the lighting device further comprises a light diffusing element, which light diffusing element is arranged to diffuse the generated light before being emitted from the lighting device.

By arranging the solid state light emitting elements at the reflector, and providing the at least one shielding portion, the light is being more diverged before reaching the light diffusing element, which results in that the distance between the solid state light emitting elements can be longer than in the prior art lighting device, or a less reflective diffusing element can be used, while still obtaining a uniform light output. Additionally, the shielding portion, or portions, increases the freedom of positioning the solid state light emitting elements.

For the purposes of this application it should be noted that by “light diffusing” is meant different kinds of light diffusing properties, such as for instance diffuse and specular transmission, and diffuse or specular reflection. Typically, the diffusing element provides a combination of several different kinds. Furthermore, the diffusing element can be a separate part, a coating, integrated in the light outlet portion, etc. As regards the reflector, it can be specular reflective, diffuse reflective or a combination thereof.

In accordance with an embodiment of the lighting device the solid state light emitting elements are arranged to emit the generated light towards the reflector, which reflector is arranged to reflect light towards the light outlet portion passed the reflector opening. Since the solid state light emitting elements are arranged to emit light towards the reflector, the generated light is reflected by the reflector at least once before reaching the light outlet portion

In accordance with an embodiment of the lighting device, the at least one shielding portion comprises opposite elongate shielding reflector portions, which extend along the length of the tubular portion, and which define the reflector opening.

In accordance with an embodiment of the lighting device, the solid state light emitting elements are mounted on an underside of said at least one shielding reflector portion.

In accordance with an embodiment of the lighting device, an inner surface of the reflector comprises two major flat elongated portions, which are interconnected at long side edges thereof, forming a V-shaped groove. This allows the incident light hitting the V-shaped grove to be fully collected and to be directly reflected towards the light outlet portion.

In accordance with an embodiment of the lighting device, the reflector covers half of an inner wall of the tube, and that a maximum outer width of the reflector is equal to the inner diameter of the tube. This embodiment provides for a click-in function of the reflector, i.e. the reflector is mountable and kept in place in the tube without separate mounting means.

In accordance with an embodiment of the lighting device, the solid state light emitting elements are arranged in two opposite lines, wherein the solid state emitting elements of each line are arranged at a predetermined spacing, and that the solid state light emitting elements of one of the lines are displaced by half the spacing along the length of the tube relative to the solid state light emitting elements of the other line. This displacement increases the uniformity of the light output.

In accordance with an embodiment of the lighting device, the solid state light emitting elements are direct emitting elements, wherein emitting sides of the solid state light emitting elements are facing away from the light outlet portion. Thereby the freedom of positioning the light emitting elements is increased.

In accordance with an embodiment of the lighting device, it further comprises a remote phosphor unit, which is mounted at the reflector opening and covers the reflector opening. This embodiment allows the use of blue solid state light emitting elements, and further enhances the uniformity of the light output. The distance between the remote phosphor and the diffuser also allows less visibility of the remote phosphor when the lighting device is off.

In accordance with an embodiment of the lighting device, the light outlet portion is provided with light diffusing properties and constitute the light diffusing element. Thereby no separate diffusing element has to be arranged.

In accordance with an embodiment of the lighting device, the remote phosphor unit additionally covers an inside of the reflector. This embodiment further increases the uniformity of the light output.

These and other aspects and advantages of the invention will be apparent from and elucidated with reference to the embodiments described hereinafter.

### BRIEF DESCRIPTION OF THE DRAWINGS

The invention will now be described in more detail and with reference to the appended drawings in which:

FIG. 1 is a schematic perspective view of a part of an embodiment of a lighting device according to the present invention;

FIGS. 2-4 are schematic cross-sectional views of different embodiments of a lighting device according to the present invention;

FIG. 5 is a schematic illustration of solid state light emitting element arrangement according to an embodiment of the lighting device;

FIGS. 6-10 are schematic cross-sectional views of embodiments of a lighting device according to the present invention.

### DESCRIPTION OF PREFERRED EMBODIMENTS

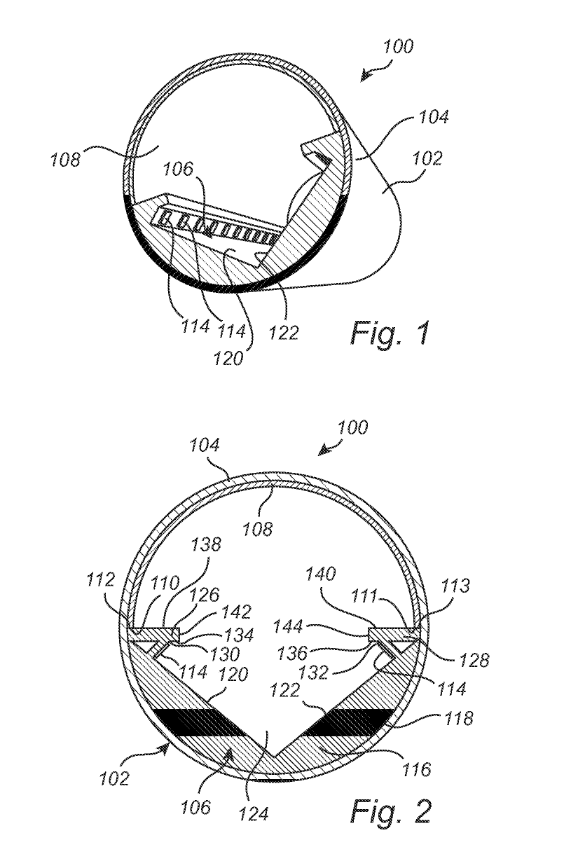

A first embodiment of the lighting device 100 according to this invention, as shown in FIGS. 1 and 2, comprises a tubular portion, or outer tube, 102, which is elongate and which has a light transmissive light outlet portion 104. In fact, in this embodiment, more particularly, the whole outer tube 102 is light transmissive, such as a glass tube, but due to a reflector 106 mounted within in the tube 102, and covering about half the tube 102, there is left the light outlet portion 104, thus constituting about half the tube 102 or less than half the tube, for the light output of the lighting device 100. Furthermore, a semi-cylindrical diffusing element 108 is arranged inside of the glass tube 104. More particularly, the extension of the diffusing element 108 corresponds with the extension of the light outlet portion 104. The diffusing element 108 is a diffusing layer deposited on the inner surface of the tube 102. Alternatively, the diffusing element can be an individual element, i.e. a separate diffuser, mounted in the tube 102 between a reflector opening, see below, and the light outlet portion 104. As a further alternative, the diffusing properties can be provided by the light outlet portion 104, thereby saving one step of manufacturing the lighting device. On the other hand it can be economically advantageous to be able to use standard transparent glass or plastic tubes. The longitudinal edges 110, 111 of the diffusing element 108 are adjacent to longitudinal portions 112, 113 of the reflector 106. Solid state light emitting elements 114 are mounted at the reflector 106. For the purposes of the present application, in the following description the solid state light emitting elements 114 will be exemplified by LEDs (Light Emitting Diodes), while any other kind of solid state light emitting element is applicable as well.

The reflector is generally semi-cylindrically shaped, and comprises a major portion 116, having a semi-cylindrical outer surface 118 abutting against the inside of the tube 102, and an opposite inner surface, which is constituted by two flat rectangular portions 120, 122, which are interconnected at an angle, for instance a right angle, at long side edges thereof thereby forming a V-shaped groove 124. Other angles are useful as well both smaller and larger than 90°. The reflector 106 further comprises elongate edge portions 126, 128 extending longitudinally along the length of the tube 102, and extending laterally along the diameter of the tube 102. The edge portions 126, 128 constitute shielding reflector portions, which shield the light generated by the LEDs 114 from being emitted directly towards the diffusing element 108. Each edge portion 126, 128 has an elongate first inner surface portion 130, 132 which is interconnected with a respective one of the flat rectangular portions 122, 124, at a right angle, and thus faces the other one of the rectangular portions 124, 122. The LEDs 114 are mounted on the first inner surface portions 130, 132. Furthermore, each edge portion 126, 128 has an elongate second inner surface portion 134, 136 interconnected with the first inner surface portion 126, 128 at an angle, and extending diametrically of the tube 102. Furthermore, each edge portion 126, 128 has an outer surface portion 138, 140 interconnected with the semi-cylindrical outer surface 118 at right angle and including a respective one of the above-mentioned longitudinal edges 112, 113. Finally, each edge portion 126, 128 has an edge surface 142, 144 interconnecting the second inner surface portion 134, 136 with the outer surface portion 138, 140. The edge surfaces 142, 144 face each other, and define the reflector opening.

The second inner surface portions 134, 136 prevent side emission, if any, of the LEDs 114 from exiting directly through the reflector opening 146. Thereby all light generated by the LEDs 114 is reflected at least once by the reflector 106, primarily the flat rectangular portions 122, 124, before reaching the diffusing element 108. The diffusing element 108 partly reflects and partly transmits the light. A common type of tubular lighting devices 100 has a diameter of 25.4 mm and a wall thickness of 1 mm. In order to obtain a good uniformity of the distribution of the light output and a high optical efficiency, for such a lighting device 100, the LEDs 114 were mounted at a spacing, also called pitch, of 30 mm, i.e. the distance between two adjacent LEDs 114, and a diffusing element 108 having 29% diffuse reflectivity, 69% transmission, which in turn was partly diffuse and partly specular, and 2% absorption was chosen. The reflector 106 had 98% specular reflection and 2% absorption. Alternatively, the reflector 106 can be diffuse reflective or a mixture of specular and diffuse reflective. For each possibility the invention works better than the state of the art devices. The specular reflector 106 gives the highest efficiency with somewhat lower uniformity of light output, and the diffuse reflector gives a somewhat lower efficiency but higher uniformity of light output. For example, the reflector can be provided with MCPET (Micro Cell Polyethylene Terephthalate), with less than 2%-8% absorption. The optical efficiency achieved was in the range of 85-90%. A uniformity of light output in the area of 90-95% is achieved as measured by direct view from the light outlet portion 104. The definition is given by (maximum luminance−minimum luminance)/(average luminance).

In order to make them contribute to the high optical efficiency, the PCBs (Printed Circuit Boards) or components or reflector carrying the LEDs 114 have been made highly reflective, such as at least 87% reflectivity. Additionally, LEDs with encapsulated lenses will further increase the optical efficiency. The lenses can have any shape to further direct light to the reflector 106.

In the above example, the LEDs 114 were mounted in two opposite lines at the underside (that is pointing away from the light outlet portion) of the shielding reflector portions 126, 128 as described above. However, by mutually displacing the LED lines the uniformity of light output was further increased. More particularly, according to a second embodiment of the lighting device, as illustrated in FIG. 5, the LEDs of both lines are mounted with the same spacing S, but the LEDs 502 of one line are displaced by half the spacing S relative to the LEDs 504 of the other line.

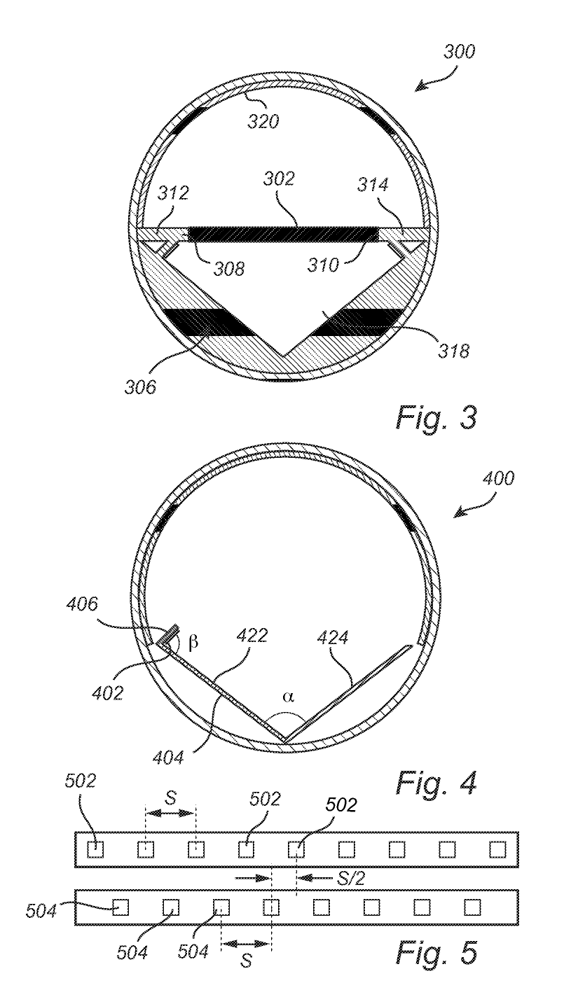

A third embodiment 300 of the lighting device, shown in FIG. 3, includes all parts of the first embodiment 100, and they are similarly arranged. However, additionally, the third embodiment of the lighting device 300 comprises a remote phosphor unit 302 mounted at the reflector opening 304 of the reflector 306. The remote phosphor unit 302 is rectangular and is connected with the edge surfaces 308, 310 of the shielding reflector portions 312, 314 and forms a lid of the reflector 306. Thereby a light mixing chamber 318 defined by the reflector 306 and the remote phosphor unit 302 is provided. This embodiment is typically used when the LEDs 316 are emitting blue light, which is to be converted, by means of the remote phosphor unit 302, into white light. In this embodiment the light reaching the diffusing element 320 is substantially more uniform than the light reaching the diffusing element in the first embodiment. Thus, it is possible to use a more transmissive diffusing element in order to increase the optical efficiency, or the light output is even more uniform than in the first embodiment. Another advantage of this embodiment is that the distance between the remote phosphor unit 302 and the diffusing element 320 prevents that a possible unfavorable color of the remote phosphor element does not appear to a user in an off state.

According to a fourth embodiment of the lighting device 400, as shown in FIG. 4, a single line of LEDs 402 is mounted at the reflector 404, at a single shielding reflector portion 406 thereof. It should be noted that in FIG. 4 the reflector is illustrated as a simple bent plate, which is a possible embodiment but it should also be regarded as a simplification of the figure thereby addressing also other embodiments.

The angle α between the inner surface portions 422, 424, or at least between the planes in which the inner surface portions extend, as shown in FIG. 4, most preferred should be about 90°. A minimum angle for providing an acceptable operation of the lighting device 400 is about 89°. Furthermore, a maximum angle for providing an acceptable operation is about 140°. Similarly, the angle β between the emitting surface of the LEDs 402 and the inner surface portion 422, 424 at which the LEDs are mounted, should be about 75°, and about 95° at maximum, and most preferably it should be about 90°. This is true for all embodiments having a generally V-shaped reflector.

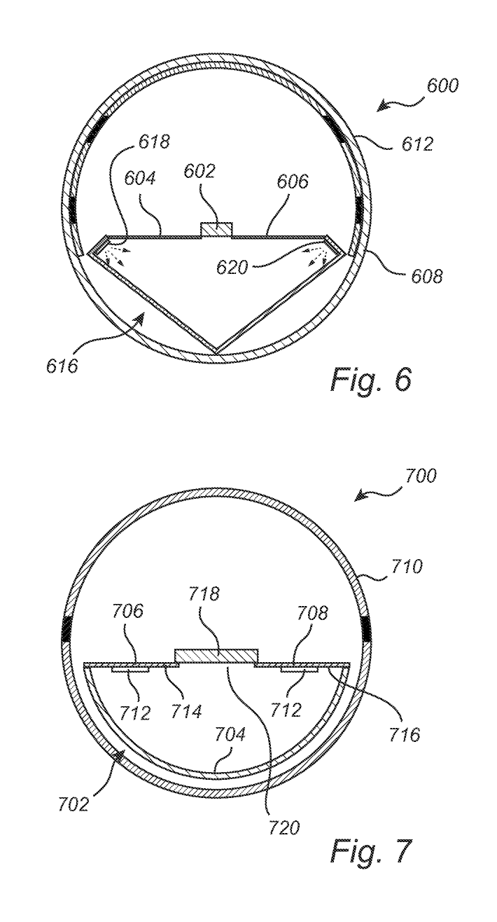

According to a fifth embodiment of the lighting device 600, as shown in FIG. 6, it is similar to the third embodiment, including an outer tube 612, a diffusing element 614 arranged on the inside of the outer tube covering the light outlet portion thereof, and a reflector 616 carrying opposite lines of LEDs 618, 620. However, the remote phosphor unit 602 is narrower than in the third embodiment as is the reflector opening 610. The shielding reflector portions 604, 606 which are provided at either side of the remote phosphor unit 602, and which extend coplanar with the remote phosphor unit 602 and define the reflector opening 610, are substantially wider than the corresponding shielding portions 312, 314 of the reflector 306 of the third embodiment. The width of the remote phosphor unit 602 is less than the radius of the tube 608. In this embodiment less phosphor material is used.

According to a sixth embodiment of the lighting device 700, as shown in FIG. 7, the inner surface 704 of a major portion of the reflector 702 has a semi-cylindrical shape, and reflector comprises flat shielding reflector portions 706, 708, which has a lateral extension which is diametrical of the tube 710. LEDs 712 are mounted at the inner surfaces 714, 716 of the shielding portions 706, 708. The LEDs 712 face the semi-cylindrical inner surface 704 of the major portion of the reflector 702. This embodiment uses blue LEDs 712, and a remote phosphor unit 718 covers a reflector opening 720 defined by the shielding portions 706, 708.

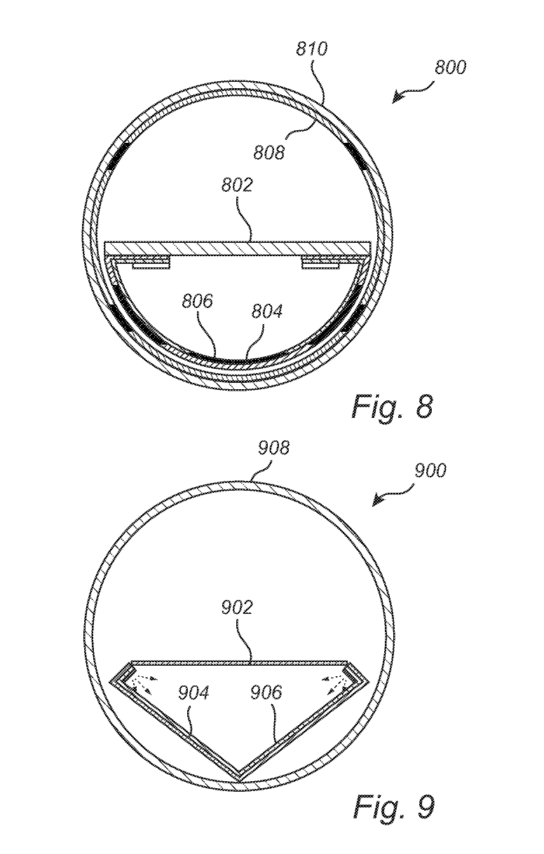

According to seventh and eighth embodiments of the lighting device 800, 900, as shown in FIGS. 8 and 9, respectively, which comprise a remote phosphor unit 802, 902, the inner surface 804, 904 of the major portion of the reflector is provided with phosphor 806, 906 as well. Furthermore, according to the seventh embodiment, in order to make the rotational position of the reflector arbitrary the diffusing element 808 is a full tube arranged coaxially with the outer tube 810, for instance as a coating of the inside of the outer tube 810. To the contrary, in the eighth embodiment of the lighting device 900 the diffusing element is integral with/integrated in the outer tube 908. In other words, the outer tube 908 has been provided with diffusing properties and operates as a diffusing element.

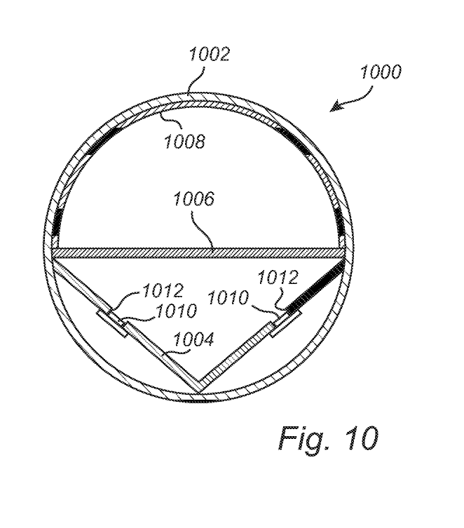

According to a ninth embodiment of the lighting device 1000, as shown in FIG. 10 in a cross-sectional view, it comprises an elongated tubular portion 1002 housing a reflector 1004, a remote phosphor unit 1006 covering the whole reflector opening, a light diffusing element 1008 covering the light outlet portion, and LEDs 1010, which are mounted at the reflector 1004. More particularly, the LEDs 1010 are mounted on the outer surface of the reflector 1004, and emit light through holes 1012 of the reflector 1004, and preferably extend into the holes 1012. The LEDs 1010 are emitting light both towards the inner surface of the reflector 1004 and directly towards the remote phosphor unit 1006. In this embodiment the remote phosphor unit 1006 constitutes a shielding portion, though light transmissive, preventing the generated light from passing the reflector opening unaffected directly from the LEDs 1010. The combined effect of the remote phosphor unit 1006 and the light diffusing element 1008 is enough to avoid spottiness although the LEDs 1010 partly do emit light directly towards the remote phosphor unit 1006 without being first reflected by the reflector 1004.

Above embodiments of the lighting device according to the present invention as defined in the appended claims have been described. These should only be seen as merely non-limiting examples. As understood by the person skilled in the art, many modifications and alternative embodiments are possible within the scope of the invention as defined by the appended claims.

For instance alternative mounting positions of the LEDs are possible in all embodiments, as understood by the person skilled in the art in light of the description. However, the alternative mounting positions may be less favorable than those disclosed herein.

Furthermore, the tubular portion can have an arbitrary cross-section, i.e. for instance square, semi-cylindrical, etc.

It is to be noted that for the purposes of his application, and in particular with regard to the appended claims, the word “comprising” does not exclude other elements or steps, and the word “a” or “an” does not exclude a plurality, which per se will be evident to a person skilled in the art.

1. A lighting device comprising:
a tubular portion, which is elongate and which has a light transmissive light outlet portion;
solid state light emitting elements configured to generate light, which is outlet through the light outlet portion;
a reflector mounted within the tubular portion, wherein the reflector is non-planar and defines a reflector opening, the solid state light emitting elements are mounted at the reflector, and the reflector is provided with at least one shielding portion, shielding the generated light from passing directly from the solid state light emitting elements through the reflector opening,
wherein the reflector having an inner surface comprising two substantially flat elongated portions that are interconnected at lone side edges thereof forming a V-shaped groove.

2. The lighting device according to claim 1, further comprising a light diffusing element, which light diffusing element is arranged to diffuse the generated light before being emitted from the lighting device.

3. The lighting device according to claim 1, wherein the solid state light emitting elements are arranged to emit the generated light towards the reflector, which reflector is arranged to reflect light towards the reflector opening.

4. The lighting device according to claim 3, said at least one shielding portion comprising opposite elongate shielding reflector portions, which extend along the length of the tubular portion and define the reflector opening.

5. The lighting device according to claim 4, wherein the solid state light emitting elements are mounted on an inner surface portion of said at least one shielding reflector portion.

6. (canceled)

7. The lighting device according to claim 5, wherein an inner surface of the reflector is semi-cylindrical.

8. The lighting device according to claim 7, wherein the reflector covers half of an inner wall of the tubular portion, and that a maximum outer width of the reflector is equal to the inner diameter of the tubular portion.

9. The lighting device according to claim 8, wherein the solid state light emitting elements are arranged in two opposite lines, wherein the solid state light emitting elements of each line are arranged at a predetermined spacing, and that the solid state light emitting elements of one of the lines are displaced by half the spacing along the length of the tubular portion relative to the solid state light emitting elements of the other line.

10. The lighting device according to claim 9, wherein the solid state light emitting elements are direct emitting elements, wherein emitting sides of the solid state light emitting elements are facing away from the light outlet portion.

11. The lighting device according to claim 10, wherein the light diffusing element is arranged on an inside of the light outlet portion.

12. The lighting device according to claim 10, wherein the light outlet portion is provided with light diffusing properties and constitutes the light diffusing element.

13. The lighting device according to claim 12, further comprising a remote phosphor unit, which is mounted at the reflector opening and covers the reflector opening.

14. The lighting device according to claim 13, wherein the remote phosphor unit additionally covers an inside of the reflector.
